(19) United States
(12) Patent Application Publication
(10) Pub. No.: US 2013/0325354 A1
(43) Pub. Date: Dec. 5, 2013

(54) COMPUTERIZED METHOD FOR CORRELATING AND ELUCIDATING CHEMICAL STRUCTURES AND SUBSTRUCTURES USING MASS SPECTROMETRY

(71) Applicant: Marshall Siegel, Fair Lawn, NJ (US)

(72) Inventor: Marshall Siegel, Fair Lawn, NJ (US)

(21) Appl. No.: 13/898,450

(22) Filed: May 20, 2013

Related U.S. Application Data
(60) Provisional application No. 61/648,938, filed on May 18, 2012.

(51) Int. Cl. G06F 19/00

(52) U.S. Cl. CPC G06F 19/703
USPC 702/19; 702/27

(57) ABSTRACT

The present invention is directed to a computational method for correlating and elucidating a mass spectrum with one or more proposed chemical structures.

This application claims the benefit of U.S. Provisional Patent Application No. 61/648,938, filed May 18, 2012, which is hereby incorporated by reference.

### FIELD OF THE INVENTION

The present invention is directed to a computational method for correlating a mass spectrum with one or more proposed chemical structures.

### BACKGROUND

Often a mass spectrometrist does not predict the chemical structure of a material of unknown structure but rather has a proposed or partial structure and wishes to correlate the structural details with the fragment ions appearing in the mass spectrum. On successful completion of that task, related unknown structures could be interpreted. A computerized method for correlating and interpreting fragment ion masses with the masses of molecular substructures has been proposed. Siegel, Analytica Chimica Acta, 174 (1985) 61-69; Siegel et al., Analytica Chimica Acta, 186 (1986) 163-174; Siegel et al., Analytica Chimica Acta, 237 (1990) 459-472.

There is a need for more efficient and accurate methods for correlating one or more proposed chemical structures with a mass spectrum.

### SUMMARY OF THE INVENTION

The present invention is a computerized method for correlating a mass spectrum with a proposed chemical structure or mixture of chemical structures. The method is fast and provides a high degree of accuracy.

In one embodiment, the method includes the steps of:
(a) providing (i) the bonded (fixed) superatoms for the proposed chemical structure(s), (ii) their bonds to one another, and (iii) floating superatoms that can be associated with any of the bonded superatoms;
(b) generating fragments of the proposed structure(s) based on the bonds between the superatoms in the proposed chemical structure(s), each fragment being a superatom or a combination of connected superatoms with or without associated floating superatoms;
(c) generating the predicted masses for each predicted fragment ion from the masses of the bonded and floating superatoms;
(d) for each observed ion in the mass spectrum, providing scores for one, two, or more predicted fragments generated in step (b); and
(e) optionally, providing a total score for each proposed chemical structure based on the scores of the predicted fragment ions.

The score for a fragment is a function of at least (i) the number of bond cleavages required to form the fragment from the proposed chemical structure, (ii) the number of floating superatoms in the fragment, (iii) the mass accuracy, which is defined as the difference between the predicted mass and the mass of the observed ion, and (iv) the experimental or assigned relative ion abundance for the observed ion.

The designed scoring functions for the fragments are referred to as the Weighted, Summed and Probability Scores. The Weighted, Summed, and Probability Scores are functions of the vectoral sum, added sum, and product of the normalized contributions, respectively, of (i) the mass errors between the predicted and experimental masses, and (ii) the sum of the number of bond cleavages and floating superatoms needed to generate the predicted substructure. For each fragment ion, a number of possible combinations of bonded and floating superatoms may satisfy the experimental fragmentation ion mass (within an experimental mass error). The highest scoring structure is believed to be the best fitting structure for the selected experimental mass.

Step (d) can include (i) selecting the fragments having predicted masses within a range of the observed mass, and (ii) providing scores for the selected fragments.

The method of the present invention can be used with any mass spectrometry ionization system such as electrospray, MALDI, laser desorption, EI, CI, thermospray, fast atom bombardment, and ²⁵²Cf plasma desorption including tandem mass spectrometry (MSⁿ ) where induced fragmentation of ions occur via CID, IRMPD, ECD, ETD, SID, Nozzle-Skimmer CID, or Capillary-Skimmer CID, with data acquired in either the nominal mass mode (e.g., where the measured mass has up to two significant figures after the decimal place) or exact mass mode (e.g., where the measured mass has three or more significant figures after the decimal place).

The method of the present invention can also be used to generate a predicted mass spectrum for a proposed chemical structure. This process is referred to as an in silico generation of a mass spectrum from superatoms. The method includes:
(a) generating fragments of the proposed chemical structure based on the bonds between the superatoms in the proposed chemical structure (e.g., by using the Bond Removal Method), each fragment being a superatom or a combination of connected superatoms with or without associated floating superatoms;
(b) generating the predicted masses for each experimental fragment ion from the masses of the bonded and floating superatoms;
(c) generating the predicted intensity for each fragment ion; and
(d) optionally, displaying the predicted mass spectrum using the generated predicted fragment masses and intensities. The predicted intensity can be, for example, equal to the inverse of the total number of cuts needed to produce that ion from the proposed chemical structure (i.e., the number of bonds which need to be broken plus the number of floating superatoms needed to be added or removed to obtain the predicted fragment from the proposed chemical structure). For instance, if the total number of cuts required is 4, the intensity would be 0.25. If no cuts are required, the intensity can be set to 1. If two predicted fragment ions have the same mass, the intensities of those two predicted fragment ions are summed together. The predicted intensities can optionally be normalized.

This method can be used to determine the individual compounds in a mixture of compounds. With a given set of mass spectral data, two or more structures in a mixture can be analyzed simultaneously (scored) for correlating experimental mass spectral data with substructures of the individual components. This feature is possible because the structures are independent entities from both Graph Theory and combinatorics bases.

Another embodiment of the present invention is a system for carrying out the method of correlating a mass spectrum of a material to one or more proposed chemical structures. The system includes
(a) a device for entering for each of one or more proposed structures, the (i) the bonded (fixed) superatoms for the chemical structure, (ii) their bonds to one another, and (iii) floating superatoms that can be associated with any of the bonded superatoms;
(b) a fragment generating unit for (i) generating fragments of each proposed chemical structure based on the bonds between superatoms in the proposed chemical structure, each fragment being a superatom or a combination of connected superatoms with or without associated floating superatoms, (ii) the predicted masses for each fragment from the masses of the bonded and floating superatoms, and (iii) the predicted intensity for each fragment; and
(c) a scoring unit for providing a score for a given fragment relative to an observed ion in the mass spectrum, the score being a function of at least (i) the number of bond cleavages required to form the fragment from the proposed chemical structure, (ii) the number of floating superatoms in the fragment, (iii) the mass accuracy, which is defined as the difference between the predicted mass and the mass of the observed ion, and (iv) the experimental or assigned relative ion abundance for the observed ion;
(d) optionally, a second scoring unit for providing a total score for each proposed chemical structure based on the scores of the predicted fragment ions;
(e) optionally, a display device for displaying the score(s) of the proposed structure or structures and/or fragments and optionally, the predicted mass spectrum for the proposed structure or structures and/or fragments;
(f) optionally, a mass spectrometer for obtaining the mass spectrum of the material being analyzed.

Yet another embodiment is a computer readable medium comprising code stored thereon which, when executed, performs the steps of the method of the present invention. The computer readable medium may also have stored thereon the observed mass spectrometry data, and optionally may store the predicted substructures, and related data (such as scores), and tables as described herein.

Yet another embodiment is a system that performs mass spectrometry comprising (a) a computer readable medium comprising code stored thereon which, when executed, performs the steps of the method of the present invention, (b) processing unit which can execute the steps of the method stored on the computer readable medium, and (c) optionally displaying the scores obtained by the method with the predicted fragments.

### DETAILED DESCRIPTION OF THE INVENTION

Definitions

The term “superatom” refers to a group of atoms which are not expected to undergo further fragmentation upon ionization in a mass spectrometer. There are two classes of superatoms. The first class, referred to as bonded superatoms, includes those superatoms which bond with other superatoms to form substructures of a molecule. Examples of bonded superatoms include, but are not limited to, —CH₃, —CH₂—, CH, —O—, —NH—, —CH═CH—, —C≡C—, [symbol] , C═O, phenyl, pyridyl, and —C≡N. The second class, referred to as floating superatoms, includes those superatoms used to form molecular adducts, small molecular losses and gains as well as those involved in rearrangement processes. Examples of floating superatoms include, but are not limited to, H⁺, Na⁺, K⁺, H₂O, CH₃OH, CH₃CO₂H, and CH₃NH₂, Floating superatoms can be associated with, or lost from, any bonded superatom in the molecular structure.

The term “fragment” refers to a bonded superatom, a floating superatom, or a group of bonded superatoms optionally bound to none, one or more floating superatoms which together are a substructure of a chemical structure. The mass of each fragment ion observed in a mass spectrum can be expressed as the sum of the masses of the bonded and floating superatoms constituting the fragment, which are a subset of the proposed molecular structure.

The “predicted mass” for a given chemical structure or substructure can be calculated based upon the experimental nominal masses (e.g., with no significant figures after the decimal place) or exact masses (e.g., generally with at least 3 or more significant figures after the decimal place). The predicted masses are computed for nominal mass data with the masses for the elements rounded to a whole number and for exact mass data generally using elemental masses with at least six significant figures after the decimal place. One method for analyzing a mass spectrum includes the steps of (i) mathematically converting the experimental masses of multiply charged ions to singly charged mass species, and (ii) filtering the mass spectrum to retain only the abundant low mass isotopes in the isotopic distribution associated with each unique chemical species. For example, this filtering will retain the isotopes for ¹H, ¹²C, ¹⁶O, ¹⁴N, ³²S, ³⁵Cl, ⁷⁹Br, etc.

Structure Generation

In one embodiment, for each proposed chemical structure, the bonded superatoms and floating superatoms (if any) are provided. Each bonded superatom and floating superatom may be entered by providing its chemical formula and/or formula weight. Optionally, a unique identifier for each bonded superatom and floating superatom is entered. If identifiers are not provided to one or more superatoms, the computer can assign a unique identifier to each of them. For example, the user can supply the chemical formula of the bonded superatoms and floating superatoms and the identifiers for them can be assigned by the user or the computer. The proposed structure of each molecule, expressed as a connected set of bonded superatoms, is then entered into the computer where each connection between pairs of bonded superatoms represents a bond between the superatoms.

The arrangement of bonded superatoms in a proposed chemical structure can be stored in a connectivity table. Each pair of bonded superatoms can be stored in the table. In one embodiment of the connectivity table, each row of the connectivity table stores the identifiers for each pair of superatoms which are bound together. In another embodiment, each row of the connectivity table stores a first superatom and each superatom bonded to it. The floating superatoms can be appended to the table without any bond pairs. In one embodiment, the default values for the minimum and maximum number of possible floating superatoms in a chemical structure is provided as 0 and 1, respectively. In another embodiment, the minimum and maximum number of possible floating atoms in a chemical structure is provided by the user.

In one alternative embodiment, the superatom motif for a chemical structure is drawn by the user who assigns masses, elemental formulas and identifiers to each of the superatoms, as well as, the bond connectivities between the bonded superatoms. In another embodiment, the chemical structure of the molecule is drawn by the user, and the user divides the molecule into individual bonded superatoms, for example, by circling them or drawing lines through the bonds which are broken when the molecule fragments. From the drawing, the computer can generate the connectivity table. Alternatively, the user can manually generate the connectivity table for the bonded pairs of superatoms from the chemical structure.

In one embodiment, there is no lower limit or upper limit in the computer program to the minimum or maximum number of floating superatoms which can be associated with the collection of bonded superatoms. In unique cases, the floating superatoms can have the same mass as an observed fragment ion without any bonded superatoms, e.g., the mass of m/z 23 could match the mass of the floating superatom Na⁺ which can also be an adduct of the molecular ion [M+Na]⁺ or some fragment of the natriated molecular ion.

Substructure Table

After the bonded superatoms, floating superatoms (if any), and proposed chemical structure(s) have been entered into the computer program, all possible substructures for each proposed chemical structure are determined and stored in a substructure table. If there are two or more proposed chemical structures for a given mass spectrum, the proposed chemical structures may be stored in a single substructure table or, alternatively, stored in separate tables for each proposed chemical structure.

All possible chemical structures and substructures for the bonded and floating superatoms can be generated by determining: (i) all combinations of bonded superatoms generated by the Bond Removal Method (which is discussed below), (ii) all combinations of floating superatoms, and (iii) all combinations of bonded superatoms generated by the Bond Removal Method together with all combinations of floating superatoms. The substructure table can include all three sets of possible chemical structures and their masses. Alternatively, the substructure table can include all combinations of bonded superatoms generated by the Bond Removal Method (but not include the substructures formed by removal or addition of floating superatoms); the masses of the structures formed by adding or removing floating superatoms can be calculated at a later time.

From a proposed (parent) chemical structure, a table of substructures and their corresponding masses can be generated using the Bond Removal Method. The Bond Removal Method systematically removes bonds between bonded superatoms in a combinatorial fashion, thereby, fragmenting the parent chemical structure into connected sets of bonded superatoms. The predicted nominal or exact mass of each fragment can then be calculated.

The user can supply the upper limit for the number of bonds to be removed, e.g. 4 bonds between bonded superatoms can be chosen, and the lower limit by default is set to 0 bonds to provide for the generation of the parent chemical structure. Therefore, all possible bonded superatom chemical structures and substructures with 4 or fewer bond cleavages are generated when the numbers of bonds removed are 0, 1, 2, 3 and 4 at a time. All possible superatom structures and substructures are generated by determining (i) all combinations of bonded superatoms generated by the removal of up to a predetermined number of bonds (e.g., 0, 1, 2, 3, 4 bonds) by the Bond Removal Method, (ii) all combinations of floating superatoms, and (iii) all combinations of bonded superatoms generated by the Bond Removal Method (set (i)) together with all combinations of floating superatoms.

In one embodiment, each substructure can be stored in individual rows of a substructure table. For instance, each row can store a substructure and its related information, including the bonded superatoms and floating superatoms which are present in the substructure. The actual substructure can be drawn based on the information stored in the connectivity table. Each row may also contain all or one or more of the following information about each proposed fragment: (1) the mass of the predicted substructure, (2) the experimental (observed) mass (or masses) for the predicted substructure (e.g., where the predicted mass of the substructure is within a predetermined range of the experimental mass, such as ±5 mmu or ±3 ppm) , (3) the mass error (or mass errors) between the predicted and experimental mass values, (4) the number of bonds cleaved between the bonded superatoms to make the substructure, (5) the number of “total cuts”, i.e., the sum of (a) the total number of bond cleavages and (b) the total number of floating superatoms present in the fragment, (6) the computed score for the predicted fragment, (6) the predicted elemental composition of the fragment, (7) the double bond equivalent for the structure, and (8) whether the fragment is an even electron or odd electron structure. The double bond equivalence (DBE) for a molecule CₓH_{y}N_{z}Oₙ is equal to x−0.5y+0.5z+1 and represents the total number of rings and double bonds in a molecule. The double bond equivalence is either a whole number or has a decimal place of 0.5. For singly charged ions, those with whole numbers are odd electron ions and those with decimal places of 0.5 are even electron ions.

Each of the floating superatoms when lost from a substructure (e.g., dehydration, —H₂O) is assigned a negative mass while each of the floating superatom adducts when added to a substructure (e.g., proton transfers and adducts of NH₄⁺) is assigned a positive mass. This information can be stored with each substructure.

The number of fixed superatom bond cleavages required to generate a given substructure can be computed by counting all the bond pairs in the connectivity table in which only one superatom member of the pair is present in the substructure. The number of floating superatoms associated with a given substructure, whether gained or lost from the substructure, are counted and the number is considered the number of “floating superatom bond cleavages”. The total number of fixed superatom bond cleavages and floating superatom bond cleavages is referred to as the number of “total cuts” and is used in calculating the scores for the predicted fragments.

Structural rearrangement processes can be taken into account by the use of floating superatoms. Such rearrangement processes include, but are not limited to, proton rearrangements (losses and gains), neutral molecule losses and gains, and adduct ion formations. Alternatively, anticipated structural rearrangements and substructure losses can also be built into the bonded superatom structure, e.g., expected loss of water from a bonded superatom containing an OH moiety and adjacent H can be expressed as a new and separate H₂O bonded superatom in place of the OH moiety and the adjacent H from the original bonded superatom (with the necessary adjustments in mass to the new and original bonded superatoms).

The program can also correlate two or more possible chemical structures with a given mass spectrum of a single compound or a mixture of compounds. The individual chemical structures are interpreted against the single set of mass spectral data and each structure is scored. This methodology has applications in the interpretation of mass spectral data for unknowns or partial unknowns. Other applications include the analysis of a single set of mass spectral data versus a mixture of possible metabolites and a variety of peptide sequences.

When there are two or more proposed structures for a given mass spectrum of a single compound, each proposed structure can be scored by summing up the best scores for each observed fragment ion using that proposed structure. In one embodiment, the proposed structure with the highest score is considered the best correlating structure to the mass spectrum.

The analysis of a variety of chemical structures versus an experimental mass spectrum to find the best matching structure to the spectrum is feasible with this system. This is because the system generates the masses for all possible substructure fragments for each chemical structure based upon the choice of bonded and floating superatoms and the number of superatom bond cleavages for each chemical structure.

In effect, all these predicted masses constitute an in silico generated “predicted” mass spectrum for each chemical structure chosen to be compared with an experimental mass spectrum. (The abundances of each predicted peak can be set to be equal to the inverse of the “total cuts” for each fragment or arbitrarily set to 1.0.) This is a powerful feature since identifying the chemical structure from a spectrum of an unknown compound does not require a massive library of known mass spectra but rather a reliable in silico method for generating the mass spectrum from a chemical structure. (Also, as discussed later, this in silico method to generate a “theoretical” mass spectrum can be used to generate the Match Factor scoring function.)

Metabolite identification can be expedited by the computer program by considering the the chemical structure of the starting material and the expected metabolic modifications to the starting material (e.g., demethylation, hydrolysis, oxidation and benzyl hydroxylation). The mass spectrum of the metabolite can be interpreted by considering the expected metabolite modifications as floating superatoms or by entering into the computer the expected metabolite structures and identifying the structure with the highest score. The expected metabolite modifications can be selected by the user or the program. In the event the program generates the expected metabolite modifications, the program can provide a list of possible metabolites as a list of floating superatoms, and then generate the possible substructures.

Program Execution

For each observed fragment ion mass, the program identifies all predicted fragments with masses equal to or within a range (e.g., a predetermined range such as ±5 mmu or ±3 ppm) of the observed mass. These fragments are then scored by one or more methods described below. In one embodiment, the highest scored predicted fragment for a given observed fragment ion is considered the mostly likely structure for the observed ion. In an alternative embodiment, the scoring is such that the lowest score is the most likely structure for the observed ion. The formulas described below generally provide higher scores for predicted fragments which have greater correlation to the observed fragment ion.

Scoring

In one embodiment, all molecular substructures of a proposed structure are scored which have the same masses as the fragment ions (within an experimental mass error such as ±5 mmu or ±3 ppm). The inventor has observed that, in general, the most likely predicted fragment ion structure for a given experimental mass is that proposed molecular substructure with the fewest number of bond cleavages and fewest number of floating superatoms together with the lowest mass error between the predicted and experimental masses.

The score functions can be normalized based upon experimental parameters, e.g., for mass error (i.e., the claimed mass accuracy of the mass spectrometer). In one embodiment, the bond cleavage score is normalized to 1 bond for linear molecules. In another embodiment, the bond cleavage score is normalized to 2 for cyclic molecules.

There are three types of scoring: Summed, Weighted, and Probability Scores.

Summed Score

The Summed Score can be a function of the sum of (1) the number of bond cleavages required to form the fragment from the proposed chemical structure, (2) the number of floating superatoms in the fragment, and (3) the absolute difference between the predicted mass and the measured experimental mass for the fragment (e.g., in mmu or ppm), and weighted by the relative abundance assigned to the fragment ion. These values can be normalized before being summed. In one embodiment, the Summed Score is a function of (1) a normalized value of the sum of the number of bond cleavages required to form the fragment from the proposed chemical structure, and the number of floating superatoms (whether they are gained or lost) required to form the fragment, and (2) a normalized value of the absolute difference between the predicted mass and the experimental mass for the fragment (e.g., in mmu or ppm) and weighted by the relative abundance assigned to the fragment ion.

The “number of floating superatoms (whether they are gained or lost) required to form the fragment” refers to the sum of the number of floating superatoms gained and the number of floating superatoms lost. For example, if a structure loses H₂O but gains a Na⁺, the number of floating superatoms required to form the fragment would be 2. The mass for the fragment would take into account lost floating superatoms (for example, −18 for H₂O) and gained floating superatoms (for example, +23 for Na⁺).

At a given observed mass, the Summed Score for a fragment can be equal to (s₁+s₂)*Iₐ*100/(2*ΣIₙ), where
s₁ is n₁/N, where N is the sum of (i) the number of bond cleavages required from the proposed chemical structure to form the fragment, and (ii) the number of floating superatoms in the fragment, and n₁ is a normalization value (e.g., the value 1 for linear molecules);
s₂ is n₂/|Δ|, where Δ presents the measured predicted mass minus the experimental mass for the fragment (in mmu or ppm), and n₂ is a normalization value (e.g., the value 3 mmu); and
Iₙ represents the ion abundance assigned to the fragment and ΣIₙ is the sum of the intensities of the n ions in the mass spectrum.

The ion abundance values, Iₙ, can be expressed in absolute terms as ion counts or in relative terms where each ion abundance is divided by the highest ion abundance in the spectrum and multiplied by 100. The experimental ion abundances are used when all ions are structurally significant, thereby weighting the scores accordingly. Often in a mass spectrum, structurally insignificant ions have high abundances or a minority of structurally significant ions have high abundances, with the majority of structurally significant ions of low abundance. Under these circumstances, to give the structurally significant ions greater weight the ion abundances are re-expressed such that Iₙ is set to 100%, for all the ions giving all ions equal weight, or are transformed mathematically to I′ₘ as described below, to attenuate high abundance ions while retaining the intensities of low abundance ions. The transformed data therefore resembles the raw experimental data but the structurally significant weak ions are enhanced relative to the structurally insignificant high abundance ions. The two equations below describe a possible mathematical transformation of the ion abundances.

I′ₙ=a*Iₙ^{q} for Iₙ≧a^{[1/(1-q)]} (formula (I))

and

I′ₙ=Iₙ for 0<Iₙ<a^{[1/(1-q})] (formula (II))

where generally 0<q<1 and 0<a<1. The exponent q defines the shape of the function and the coefficient ‘a’ defines the magnitude of the function. The value of ‘a’ can be chosen by deciding on the desired value for the relative intensity (r.i.) of I′ₙ when Iₙ is set to 1% r.i. The value for q can be chosen by deciding on the desired (reduced) value for I′ₙ when Iₙ is set to 100% r.i. in Formula I and the result multiplied by the chosen value for the magnitude coefficient ‘a’. When the values of q and a are determined, a^{[1/(1-q)]} is a point of intersection of Formulas I and II, i.e., where I′ₙ=Iₙ. Above this point of intersection (Iₙ>a^{[1/(1-q)]}), Formula (I) is used principally for attenuating the intensity of high abundance ions, while, below this point of intersection (Iₙ<a^{[1/(1-q)]}), Formula (II) is used to maintain the intensity of the weak ions.

For example, when a=0.75 and q=0.75, the functions can be

I′ₙ=0.75*Iₙ^{0.75} for Iₙ greater than 0.3164

and

I′ₙ=Iₙ for 0<Iₙ<a^{[1/(1-q)]}=a⁴=0.3164

where Iₙ is expressed as percent relative intensity. A peak at 100% relative intensity (Iₙ) is attenuated by 4.22 times to 23.72 relative intensity (′ₙ), a peak at 50.0% r.i. (Iₙ) is attenuated by 3.5 times to 14.10% r.i. (I′ₙ), a peak at 1.0% r.i. (Iₙ) is attenuated by 1.33 times to 0.75% r.i. (I′ₙ), and all peaks below 0.3164% r.i. (Iₙ) are not attenuated (I′ₙ=Iₙ).

Alternatively, the intensities can be transformed by a different formula to attenuate the high abundance insignificant ions while retaining the low abundance significant ions.

Another method for calculating the Summed Score is using an additional weighting function (AWF). For example, the Summed Score for a fragment can be equal to ([1−AWF]*s₁+[AWF]*s₂)*Iₙ*100/(ΣIₙ), where s₁, s₂,and Iₙ are as defined above, and AWF is an additional levered weighting function having a value of from 0.0 to 1.0. When giving equal weights to s₁ and s₂, AWF is set to 0.5.

Weighted Score

The Weighted Score can be a function of the square root of the sums of the squares of (1) the number of bond cleavages required to form the fragment from the proposed chemical structure, (2) the number of floating superatoms required to form the fragment, and (3) the absolute difference between the predicted mass and the measured experimental mass for the fragment (e.g., in mmu or ppm), and weighted by the relative abundance assigned to the fragment ion. These values can be normalized before being squared. In one embodiment, the Weighted Score is a function of the square root of the sums of the squares of (1) a normalized value of the sum of the number of bond cleavages required to form the fragment from the proposed chemical structure, and the number of floating superatoms required to form the fragment, and (2) a normalized value of the absolute difference between the predicted mass and the measured experimental mass for the fragment (e.g., in mmu or ppm), and weighted by the relative abundance assigned to the fragment ion.

At a given observed mass, the Weighted Score for a fragment can be equal to (s₁²+s₂²)^{1/2}*Iₙ*100/(2^{1/2}*ΣIₙ), where s₁, s₂, and Iₙ are as defined above (in the section entitled Summed Score). The Weighted Score follows statistical theory since it is the square root of the sums of the squares, i.e., the vector sum of the errors.

Another method for calculating the Weighted Score is using an additional weighting function (AWF). For example, the Weighted Score for a fragment can be equal to ([1−AWF]*s₁²+[AWF]*s₂²)^{1/2}*Iₙ*100/(ΣIₙ), where s₁, s₂, and Iₙ are as defined above, and AWF is an additional levered weighting function having a value of from 0.0 to 1.0. When giving equal weights to s₁ and s₂, AWF is set to 0.5.

Probability Score

The Probability Score can be a function of the product of (1) the number of bond cleavages required to form the fragment from the proposed chemical structure, (2) the number of floating superatoms in the fragment, and (3) the absolute difference between the measured predicted mass and the measured experimental mass for the fragment (e.g., in mmu or ppm), and weighted by the relative abundance assigned to the fragment ion. These values can be normalized before being multiplied. In one embodiment, the Probability Score is a function of the product of (1) a normalized value of the sum of the number of bond cleavages required to form the fragment from the proposed chemical structure, and the number of floating superatoms required to form the fragment, and (2) a normalized value of the absolute difference between the predicted mass and the measured experimental mass for the fragment (e.g., in mmu or ppm), and weighted by the relative abundance assigned to the fragment ion.

At a given observed mass, the Probability Score for a fragment can be equal to (s₁*s₂)^{r}*Iₙ*100/(ΣIₙ), where S₁, s₂, and Iₙ are as defined above (in the section entitled Summed Score) and r is an exponent for the cross-correlation of S₁ and s₂, normally set to 1 (or greater), to magnify the Probability Score when both s₁ and s₂ have high values and to dimisnish the Probability Score when both S₁ and s₂ have low values and when either one has a low value and a high value.

(Total) Maxdat Score

Given a proposed chemical structure to correlate with experimental mass spectral data, the Summed Score, Weighted Score and/or Probability Scores for each ion in the spectrum can be computed. However, for each ion, a number of possible chemical substructures may satisfy the mass spectral data within experimental mass error. The highest scoring substructure mass (irrespective of the scoring method used) is believed to be the best fitting structure for the experimental mass and this score is referred to as the Maxdat Score for the experimental ion. The summation of all the Maxdat Scores for all the experimental ions for a given proposed structure is referred to as the Total Maxdat Score. The magnitude of the Total Maxdat Score is an indicator of the degree of correlation between the experimental data and the proposed structure.

Penalty Score

In order to identify, from a number of proposed chemical structures, the chemical structure that best correlates with an observed mass spectrum, the Total Maxdat Score for each chemical structure should be adjusted by how well the observed ions match each of the proposed chemical structures.

For a given chemical structure, the Total Maxdat Score, obtained from the maximum Summed, Weighted, or Probability Score for each ion, accounts only for the observed ions that correlate with the proposed structure but ignores ions that do not correlate with the predicted structure. Such ions (i.e., the ions that do not match) are indications that the proposed chemical structure may not be fully correct. To adjust for this deficiency, the Total Maxdat Score is penalized by a Penalty Score. The Penalty Score is a function of the number of ions not accounted for in the proposed structure multiplied by the average maximum score for the ions which were accounted for in the proposed structure (i.e., the average of the Maxdat scores for the accounted ions). The Penalty Score that is subtracted from the Total Maxdat Score is UAI*ASPI, where UAI (unaccounted ions) is the number of ions not accounted for in the proposed structure (or fragment), and ASPI is the average maximum score per interpreted ion accounted for in the proposed structure (or fragment). An Adjustment Factor can be multiplied to the Penalty Score. The Adjustment Factor is used as a weighting factor for the Penalty Score and normally varies from 0 to 1, i.e., from no effect on the Maxdat Score to the full effect of missing ions on the Maxdat Score, respectively. Typically, a value of 1.0 is used.

Match Factor

In order to compare a variety of chemical structures to a given mass spectrum, the total number of predicted parent- and sub-structures for the correlated ions for a given chemical structure have to be normalized against the total number of theoretically predicted parent- and sub-structures for that given chemical structure, that would have been generated over the experimental scan range. The number of correlated structures should be consistent with the expected experimental mass errors. In addition, the number of correlated and predicted structures should be consistent with the applied fragmentation rules. This ratio is referred to as the Match Factor. Therefore, the Match Factor for a proposed chemical structure is the ratio of the total number of predicted parent- and sub-structures for the correlated ions to the total number of theoretically predicted parent- and sub-structures. The Match Factor accounts for the quality of the predicted chemical structure. The Match Factor, thereby, serves as a measure for comparing different proposed chemical structures to the experimental data. The (Total) Maxdat Score and the Penalty Score account for the quality of the experimental data since scores for observed ions are added and predicted scores for unobserved ions are subtracted. For example, in a mass spectrum for a predicted chemical structure, if 100 ions are generated of which 25 ions correlate with 125 sub-structures and the total number of predicted sub-structures for the chemical structure is 250 sub-structures, the Match Factor would be 0.50 (125/250) and is independent of the number of ions that do not match the structure (75 ions). In general, the higher the Match Factor value, the greater is the likelihood that the proposed structure is the actual structure. The Match Factor will be less than unity because the total number of theoretical substructures can be over-predicted when using floating superatoms.

Total Score

The composite score incorporating the Match Factor, the Total Maxdat Score, the Penalty Score and the Adjustment Factor is referred to as the Total Score and is expressed as

Total Score=Match Factor*[Total Maxdat Score−(Penalty Score*Adjustment Factor)]

The magnitude of the Total Score enables the ranking of a variety of proposed chemical structures to the experimental data. The proposed chemical structures with the highest Total Scores are most consistent with the experimental mass spectral data among all the proposed structures. Further enumeration of the chemical structures with the highest Total Scores (i.e., the generation of new structural entities from the mix of bonded and floating superatom structures describing the proposed chemical structures) may generate structures with even greater scores.

Weighted Match Factor/Weighted Total Score

For the Match Factor (i.e., the fraction of predicted substructures consistent with experimental mass spectral information versus all the predicted substructures for the predicted chemical structure) calculated above, all predicted parent- and sub-structures have an equal probability of formation. An alternative method for calculating the Match Factor is to compute the Weighted Match Factor. The Weighted Match Factor weights by importance the ratio of the weights for all parent- and sub-structures that correlate with the experimental data to that of weights for all predicted parent- and sub-structures. The weight (importance) of each parent- and sub-structure is defined as the inverse of the “total number of cuts” (also called the “Total Number of Disrupted Bonds”) needed for the formation of the structures from both bonded and floating superatoms that describe the proposed chemical structure. A proviso in the calculation is to set the total number of cuts for parent structures to 1 (which are formed without cuts). The Weighted Match Factor for a predicted chemical structure can be represented as:

Weighted Match Factor=Σᵢ(1/Total Cutsᵢ)/(1/Total Cutsₙ)

where i is the number of correlated experimental parent- and sub-structures, n is the total number of predicted parent- and sub-structures, and Total Cuts for a given substructure represents the total number of cuts necessary to obtain the substructure from the proposed chemical structure. Likewise, the Weighted Total Score is defined as

Weighted Total Score=Weighted Match Factor*[Total Maxdat Score−(Penalty Score*Adjustment Factor)]

A proposed chemical structure with the highest Weighted Total Score from a number of tested proposed structures is the most likely structure to match the experimental data. Further enumeration of the chemical structures with the highest Weighted Total Scores may generate structures with even greater scores.

Filtering/Sorting/Displaying Data

The structures can be further filtered, for example, (i) to select from all the solutions, or the Even Electron or Odd Electron solutions, depending upon the ionization and collision activation methods used to acquire the mass spectral data, (ii) to remove inconsistent stoichiometries in the elemental compositions for the potential fragments due to the generality of the combinatorics algorithm (especially when accounting for the elements of the floating superatoms lost from the proposed chemical structure), (iii) to remove predicted substructures generated through very unlikely fragmentation processes, and, (iv) to remove unlikely structures by analyzing ancillary chemical and/or spectrometric data for the observed fragment ions.

The structures with the highest score or scores for a particular fragment (e.g., the structures with the highest 1, 2, 3, 4, or 5 scores or all scores within a predetermined range) can be displayed graphically, using text (for example, showing the structure or providing the IUPAC name for the structure), or by their chemical formula.

The predicted fragment structures for each experimental ion mass can be displayed, for example, in the order of their scores, and where two or more fragments have the same or similar scores, displaying the fragments in order based on any or combination of the following factors: (i) the lowest number of “total cuts” (also referred to as the Total Number of Disrupted Bonds) (defined as the sum number of the superatom bond cleavages needed to form the fragment plus the sum total of the number of floating superatoms needed to form the substructure), (ii) the fewest number of superatom bond cleavages needed to create the fragment, (iii) lowest |Δ| value, and (iv) the lowest number of floating superatoms needed to form the fragment. For example, where two or more fragments have the same or similar scores, displaying the fragments in the following order: (i) the lowest number of total cuts and (ii) the fewest number of superatom bond cleavages needed to create the fragment. When two or more fragments have the same or similar scores, number of “total cuts”, and number of superatom bond cleavages needed to create the fragment, the method further comprises displaying the fragments in the following order: (iii) lowest |Δ| value, and (iv) the lowest number of floating superatoms needed to form the fragment. Alternatively, the fragments can be displayed based on the order of factors (ii), (iii), (i) and (iv).

In another embodiment, all structures, not just the best structural answers, can be displayed (e.g., with the scoring results, such as the Total Score). The computer program can provide a viewer for structures so that all predicted structures could be checked for reasonableness and consistency. The structures can be graphically produced based on the information in the connectivity table.

In addition, the elemental formula for the experimental masses can be determined from the proposed superatom structures and their scores for exact and/or nominal experimental mass data. The scoring procedure provides an additional avenue for determining the elemental formula for the fragment ions when, for example, a number of structural candidates are provided to describe the fragment ions. Normally, exact mass measurements are used generally to experimentally limit the number of elemental formulas and the scoring procedure further aids in selecting the correct elemental. In nominal mass measurements, the scoring procedure is a unique tool for determining the elemental formula from a number of possibilities since no ancillary exact mass measurements are available.

Removal of Systematic Mass Errors

Removal of systematic mass errors in the experimental data can be made so that only random errors remain in the experimental data, thereby, raising the Maxdat Scores for the individual ions and, hence, the Total Maxdat Score for the proposed chemical structure. This can be achieved by adding to the experimental masses the systematic error (since Δ=Theoretical Mass−Experimental Mass). For a predicted chemical structure, the Weighted Average Systematic Mass Error for the observed ions (i) is the sum of the weighted mass error for each of the ions, where the weights are the Maxdat Scores for the individual ions, i.e.,

Weighted Average Systematic Mass Error=Σ(Maxdat Scoreᵢ*Mass Error)/(Maxdat Score)

After correcting the experimental masses with the Weighted Average Systematic Mass Error, the calculation correlating the revised experimental masses with the proposed chemical structure is repeated (e.g., calculating the Summed, Weighted, or Probability Score) with the exact same parameters used initially, except of course for the experimental masses. After this first iteration, the Maxdat Scores for the individual ions are obtained as well as the Total Maxdat Score, the Penalty Score, the Match Factor and the Total Score. The Maxdat Score for each ion generally is elevated after the iteration because the removal of a systematic mass errors results in smaller experimental mass errors, thereby elevating the Summed, Weighted and Probability Scores. Usually, one or two iterations are sufficient to remove the experimental systematic mass error and to optimize the Total Maxdat Score and Total Score.

All patents, patent applications, and publications cited herein are incorporated by reference in their entireties.

1. A method for correlating the fragment ions appearing in a mass spectrum with one or more proposed parent chemical structure(s) or a mixture of parent chemical structures, the method comprising, for each proposed chemical structure:
(a) providing (i) the bonded superatoms for the proposed chemical structure, (ii) their bonds to one another, and (iii) floating superatoms bound or lost from the proposed chemical structure;
(b) generating potential fragments of the proposed structure, each potential fragment being (i) a bonded superatom, (ii) a bonded superatom bound to one or more floating superatoms, (iii) a combination of interconnected bonded superatoms optionally bound to one or more floating superatoms, or (iv) a combination of one or more floating superatoms;
(c) generating the predicted masses for each potential fragment;
(d) for each observed mass, providing scores for one, two or more potential fragments, where the score for a potential fragment is a function of (i) the number of bond cleavages required to form the potential fragment from the proposed chemical structure, (ii) the number of floating superatoms added and/or lost to produce the desired mass of the potential fragment, (iii) the mass accuracy, which is defined as the difference between (A) the predicted mass of the potential fragment and (B) the mass of a fragment ion observed in the mass spectrum (the measured experimental mass), and (iv) the assigned ion abundance of the observed fragment ion;
(e) optionally, providing a total score for each proposed chemical structure based on the scores of the predicted fragment ions; and
(f) optionally, displaying some or all of the scores for the potential fragments and/or proposed structure(s).

2. The method of claim 1, wherein in step (b), the potential fragments are generated by the simulated removal of bonds between bonded superatoms and/or the addition or removal of floating superatoms.

3. The method of claim 1 or 2, wherein step (d) comprises for each observed mass:
(i) selecting the potential fragments having predicted masses within a range of an observed mass, and
(ii) providing scores for the selected fragments.

4. The method of any one of claims 1-3, wherein the score for a potential fragment, referred to as the Summed Score, is equal to
(s₁+s₂)*Iₙ*100/(2*ΣIₙ),
where
s₁ is n₁/N, where N is the sum of (i) the number of bond cleavages between bonded superatoms required to form the fragment from the proposed chemical structure, (ii) the number of floating superatom adducts required to generate the fragment ion, and (iii) the number of floating superatom losses required to generate the fragment, and n₁ is a normalization value;
s₂ is n₂/|Δ|, where Δ represents the predicted mass minus the measured experimental mass for the fragment, and n₂ is a normalization value; and,
Iₙ represents the ion abundance (intensity) assigned to the fragment ion, ΣIₙ represents the total ion abundance (intensity) for the ions in the mass spectrum and Iₙ/ΣIₙ represents the relative ion abundance (relative ion intensity) of each ion in the mass spectrum.

5. The method of any one of claims 1-3, wherein the score for a potential fragment, referred to as the Weighted Score, is equal to
(s₁²+s₂²)^{1/2}*Iₙ*100/(2^{1/2}*ΣIₙ),
where
s₁ is n₁/N, where N is the sum of (i) the number of bond cleavages between bonded superatoms required to form the fragment from the proposed chemical structure, (ii) the number of floating superatom adducts required to generate the fragment ion, and (iii) the number of floating superatom losses required to generate the fragment, and n₁ is a normalization value;
s₂ is n₂/|Δ|, where Δ represents the the predicted mass minus the measured experimental mass for the fragment, and n₂ is a normalization value; and,
Iₙ represents the ion abundance (intensity) assigned to the fragment ion, ΣIₙ represents the total ion abundance (intensity) for the ions in the mass spectrum and Iₙ/ΣIₙ represents the relative ion abundance (relative ion intensity) of each ion in the mass spectrum.

6. The method of any one of claims 1-3, wherein the score for a potential fragment, referred to as the Probability Score, is equal to
(s₁+s₂)^{r}*Iₙ*100/ΣIₙ),
where
s₁ is n₁/N, where N is the sum of (i) the number of bond cleavages between bonded superatoms required to form the fragment from the proposed chemical structure, (ii) the number of floating superatom adducts required to generate the fragment ion, and (iii) the number of floating superatom losses required to generate the fragment, and n₁ is a normalization value;
s₂ is n₂/|Δ|, where Δ represents the predicted mass minus the measured experimental mass for the fragment, and n₂ is a normalization value;
r is an exponent to magnify or diminish the cross-correlation values of s1 and s2; and
Iₙ represents the ion abundance (intensity) assigned to the fragment ion, ΣIₙ represents the total ion abundance (intensity) for the ions in the mass spectrum and Iₙ/ΣIₙ represents the relative ion abundance (relative ion intensity) of each ion in the mass spectrum.

7. The method of any one of claims 1-3, wherein the score for a potential fragment, referred to as the AWF modified Summed Score, is equal to
([1−AWF]*s₁+[AWF]*s₂)*Iₙ*100/(ΣIₙ),
where
AWF is an additional weighting function having a value of from 0.0 to 1.0, levering the relative weights between s₁, related to the number of bonds and floating superatoms needed for the formation of the fragment ion from the proposed parent structure, and s₂, related to the mass error [|Δ|];
s₁ is n₁/N, where N is the sum of (i) the number of bond cleavages between bonded superatoms required to form the fragment from the proposed chemical structure, (ii) the number of floating superatom adducts required to generate the fragment ion, and (iii) the number of floating superatom losses required to generate the fragment, and n₁ is a normalization value;
s₂ is n₂/|Δ|, where Δ represents the predicted mass minus the measured experimental mass for the fragment, and n₂ is a normalization value; and
Iₙ represents the ion abundance (intensity) assigned to the fragment ion, ΣIₙ represents the total ion abundance (intensity) for the ions in the mass spectrum and Iₙ/ΣIₙ represents the relative ion abundance (relative ion intensity) of each ion in the mass spectrum.

8. The method of any one of claims 1-3, wherein the score for a fragment, referred to as the AWF modified Weighted Score, is equal to
([1−AWF]*s₁²+[AWF]*s₂²)^{1/2}*Iₙ*100/ΣIₙ,
where
AWF is an additional weighting function having a value of from 0.0 to 1.0, levering the relative weights between S₁, related to the number of bonds and floating superatoms needed for the formation of the fragment ion from the proposed parent structure, and s₂, related to the mass error [|Δ|];
s₁ is n₁/N, where N is the sum of (i) the number of bond cleavages between bonded superatoms required to form the fragment from the proposed chemical structure expressed as bonded superatoms, (ii) the number of floating superatom adducts required to generate the fragment ion, and (iii) the number of floating superatom losses required to generate the fragment, and n₁ is a normalization value;
s₂ is n₂/|Δ|, where Δ represents the the predicted mass minus the measured experimental mass for the fragment, and n₂ is a normalization value; and,
Iₙ represents the ion abundance (intensity) of the fragment ion, ΣIₙ represents the total ion abundance (intensity) for the ions in the mass spectrum and Iₙ/ΣIₙ represents the relative ion abundance (relative ion intensity) of each ion in the mass spectrum.

9. The method of any one of claims 1-3, wherein the score for a proposed chemical structure, referred to as the Total Score, is equal to:
Total Score=Match Factor*[Total Maxdat Score−(Penalty Score*Adjustment Factor)]
wherein
the Match Factor is the ratio of the total number of predicted parent- and sub-structures for all the correlated ions of a mass spectrum for a proposed chemical structure to the total number of predicted parent- and sub-structures for the proposed chemical structure consistent with the experimental scan parameters and the fragmentation rules;
the Total Maxdat Score is the summation of the highest scores for each correlating experimental ion;
the Penalty Score is UAI*ASPI, where UAI (unaccounted ions) is the number of ions not accounted for in the proposed chemical structure, and ASPI is the average maximum-score per interpreted ion accounted for in the proposed chemical structure; and
the Adjustment Factor is used as a weighting factor for the Penalty Score and varies from 0 to 1.

10. The method of any one of claims 1-9, wherein prior to generating scores for each fragment ion, the intensities for each observed mass are either (i) retained, (ii) set to 100%, or (iii) transformed to attenuate high abundance ions of structurally less significant ions, while retaining the intensities of the low abundance ions of structurally more significant ions.

11. The method of any one of claims 4-8, wherein the intensities used in the scoring have been transformed according to the formulas (I) and (II)
I′ₙ=a*Iₙ^{q} for Iₙ≧a^{[1/(1-q)]} (formula (I))
and
I′ₙ=Iₙ for 0<Iₙ<a^{[1/(1-q})] (formula (II))
where 0<q<1 and 0<a<1, and wherein the variables Iₙ′ are used as the intensities in the Summed Score, Weighted Score or Probability Score calculations.

12. The method of any of the preceding claims, wherein the proposed chemical structure(s) is a metabolite of a parent compound.

13. The method of any of the preceding claims, wherein the proposed chemical structure(s) is a natural product, pharmaceutical, pesticide, small molecule, biomolecule, saccharide, nucleotide, or a peptide, or a protein or antibody with a post-translational modification(s).

14. The method of any of the preceding claims, further comprising displaying the predicted fragment structures for each experimental ion mass in the order of their scores, and where two or more fragments have the same or similar scores, displaying the fragments in order based on any one or more of the following factors: (i) the lowest number of “total cuts” (defined as the sum number of the superatom bond cleavages needed to form the fragment plus the sum total of the number of floating superatoms needed to form the substructure), (ii) the fewest number of superatom bond cleavages needed to create the fragment, (iii) lowest |Δ| value, and (iv) the lowest number of floating superatoms needed to form the fragment.

15. The method of claim 14, wherein two or more fragments having the same or similar scores are displayed in the order of factors (i), (ii), (iii) and then (iv).

16. The method of claim 14, wherein two or more fragments having the same or similar scores are displayed in the order of factors (ii), (iii), (i), and then (iv).

17. The method of any of the preceding claims, further comprising filtering the fragment ion solutions with scores (i) to select from all the solutions, or the Even Electron or Odd Electron solutions, depending upon the ionization and collision activation methods used to acquire the mass spectral data, (ii) to remove inconsistent stoichiometries in the elemental compositions for the potential fragments due to the generality of the combinatorics algorithm, (iii) to remove predicted substructures generated through very unlikely fragmentation processes, and (iv) to remove unlikely structures by analyzing ancillary chemical and/or spectrometric data for the observed fragment ions.

18. The method of any of the preceding claims, further comprising:
(g) determining the elemental formula for the experimental masses from the proposed superatom structures and their scores for exact and/or nominal experimental mass data; and
(h) optionally, enumerating the highest scoring proposed chemical structures to generate even higher scoring proposed chemical structures to the experimental data.

19. The method of any of the preceding claims, wherein the score for a proposed chemical structure, referred to as the Weighted Total Score, is equal to:
Weighted Total Score=Weighted Match Factor*[Total Maxdat Score−(Penalty Score*Adjustment Factor)]
wherein
the Weighted Match Factor is Weighted Match Factor=Σᵢ (1/Total Cutsᵢ)/(1/Total Cutsₙ)
where i is the number of correlated experimental parent- and sub-structures, n is the total number of predicted parent- and sub-structures, and Total Cuts for a given structure represents the total number of cuts necessary to obtain the structure from the proposed chemical structure for the parent compound represented as bonded and floating superatoms;
the Total Maxdat Score is the summation of the highest scores for each correlating experimental ions;
the Penalty Score is UAI*ASPI, where UAI (unaccounted ions) is the number of ions not accounted for in the proposed chemical structure, and ASPI is the average maximum-score per interpreted ion accounted for in the proposed chemical structure; and
the Adjustment Factor is used as a weighting factor for the Penalty Score and varies from 0 to 1.

20. The method of any of the preceding claims, wherein after step (d), the method includes (I) calculating a Weighted Average Systematic Mass Error for a proposed chemical structure to take systematic mass errors in the experimental mass data into account (e.g., according to the formula
Weighted Average Systematic Mass Error=Σ(Maxdat Scoreᵢ*Mass Errorᵢ)/(Maxdat Scoreᵢ)
where the Maxdat Score is the highest score for a substructure for a given experimental mass i, and the Mass Error is the experimental mass error for experimental mass i), (II) correcting the experimental masses with the Weighted Average Systematic Mass Error, and (III) repeating step (d) with the corrected experimental masses.

21. A system for correlating a mass spectrum of a material to one or more proposed chemical structures, the system comprising
(a) a device for entering for each of one or more proposed structures, the (i) the bonded (fixed) superatoms for the chemical structure, (ii) their bonds to one another, and (iii) floating superatoms that can be associated with any of the bonded superatoms;
(b) a fragment generating unit for (i) generating fragments of each proposed chemical structure based on the bonds between superatoms in the proposed chemical structure, each fragment being a superatom or a combination of connected superatoms with or without associated floating superatoms, (ii) the predicted masses for each fragment from the masses of the bonded and floating superatoms, and (iii) the predicted intensity for each fragment; and
(c) a scoring unit for providing a score for a given fragment relative to an observed ion in the mass spectrum, the score being a function of at least (i) the number of bond cleavages required to form the fragment from the proposed chemical structure, (ii) the number of floating superatoms in the fragment, (iii) the mass accuracy, which is defined as the difference between the predicted mass and the mass of the observed ion, and (iv) the experimental or assigned relative ion abundance for the observed ion;
(d) optionally, a second scoring unit for providing a total score for each proposed chemical structure based on the scores of the predicted fragment ions;
(e) optionally, a display device for displaying the score(s) of the proposed structure or structures and/or fragments and optionally, the predicted mass spectrum for the proposed structure or structures and/or fragments;
(f) optionally, a mass spectrometer for obtaining the mass spectrum of the material being analyzed.

22. A method for generating in silico a mass spectrum from a proposed chemical structure, where the proposed chemical structure is comprised of a plurality of superatoms and optionally one or more floating superatoms, the method comprising:
(a) generating fragments of the proposed chemical structure based on the bonds between the superatoms in the proposed chemical structure, each fragment being a superatom or a combination of connected superatoms with or without associated floating superatoms;
(b) generating the predicted masses for each experimental fragment ion from the masses of the bonded and floating superatoms;
(c) generating the predicted intensity for each fragment ion, wherein the predicted intensity for each fragment ion is inverse to the total number of cuts needed to generate the fragment from the proposed chemical structure; and
(d) optionally, displaying the predicted mass spectrum using the generated predicted fragment masses and intensities, wherein the intensities of fragment ions having the same mass are summed together.
